(19) United States
(12) Patent Application Publication
(10) Pub. No.: US 2016/0132965 A1
(43) Pub. Date: May 12, 2016

(54) Systems and Methods for Dynamic Currency Conversion

(71) Applicant: MASTERCARD ASIA PACIFIC PTE. LTD., SINGAPORE (SG)

(72) Inventors: Sandeep Malhotra, Stamford, CT (US); Tadepally Venkata Seshadri, Singapore (SG); Manohar Murali, Singapore (SG)

(21) Appl. No.: 14/933,667

(22) Filed: Nov. 5, 2015

(30) Foreign Application Priority Data
Nov. 6, 2014 (SG) 10201407277P

(51) Int. Cl. G06Q 40/04

(52) U.S. Cl. CPC G06Q 40/04

(57) ABSTRACT

Systems and methods for dynamic currency conversion and a server for an intermediary that transmits messages between participants of a transaction which requires currency conversion are provided. An exemplary method comprises determining that a transaction requires currency conversion, and obtaining at an intermediary a currency conversion rate for the currency conversion, wherein the intermediary transmits messages between participants of the transaction and where the messages enable each of the participants to perform their part in the transaction. The method also comprises facilitating the currency conversion using the currency conversion rate to obtain an amount of the transaction in a desired currency.

### FIELD

The following generally discloses systems and methods for conducting dynamic currency conversion.

### BACKGROUND

This section provides background information related to the present disclosure which is not necessarily prior art.

One advantage a payment instrument, such as a credit card, provides to its holder is the convenience of facilitating cashless transactions. The credit card also allows cashless transactions to include cross border transactions, which are purchases that are made in a currency that is not the one that the credit card uses or is assigned. For example, a credit card that is issued by a Thai bank, denominated in Thai Baht, can be used to purchase goods from a merchant located in the US, where the transaction is done in US dollars.

Such cross border transactions are generally processed over a network of participants, similar to the network of participants involved in a non-cross border transaction, before the credit card holder or the issuer of the credit card is made aware of the transaction amount in the currency assigned to the credit card. Depending on the processing that occurs at each participant, one disadvantage is that the issuer of the credit card may not even be aware, from the transaction details, that the transaction is a cross border one.

Further in a cross border transaction, it is preferred that a designated participant in the network of participants conducts the currency conversion. However, a non-designated participant may be configured to undertake the currency conversion at a currency exchange rate that is determined by the non-designated participant, which may apply a conversion rate that may be higher than a market rate applicable at the time of the transaction.

There is thus a need to improve upon the transparency of cross-border transactions, especially with an increase in demand for such services.

### SUMMARY

This section provides a general summary of the disclosure, and is not a comprehensive disclosure of its full scope or all of its features. Aspects and embodiments of the disclosure are also set out in the accompanying claims.

According to a first aspect of the present disclosure, there is provided a method for dynamic currency conversion, the method comprises determining that a transaction requires currency conversion; obtaining at an intermediary a currency conversion rate for the currency conversion, wherein the intermediary transmits messages between participants of the transaction, the messages enabling each of the participants to perform their part in the transaction; and facilitating the currency conversion using the currency conversion rate to obtain an amount of the transaction in a desired currency.

According to a second aspect of the disclosure, there is provided a server for an intermediary that transmits messages between participants of a transaction which requires currency conversion, the messages enabling each of the participants to perform their part in the transaction, the intermediary server comprises at least one processor; and at least one memory including computer program code; the at least one memory and the computer program code configured to, with the at least one processor, cause the intermediary server at least to: obtain a currency conversion rate for the currency conversion; and facilitate the currency conversion using the currency conversion rate to obtain an amount of the transaction in a desired currency.

According to a third aspect of the disclosure, there is provided a server for an issuer of a payment instrument used to initiate a transaction which requires currency conversion, the issuer server comprising: at least one processor; and at least one memory including computer program code; the at least one memory and the computer program code configured to, with the at least one processor, cause the server at least to: communicate with the intermediary server; and receive the amount of the transaction in a currency accepted by a party where the transaction is initiated.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Embodiments of the present disclosure will be better understood and readily apparent to one of ordinary skill in the art from the following written description, by way of example only, and in conjunction with the drawings, in which:

FIG. 1A shows a schematic of a prior art process for a regular cross border transaction.

FIG. 1B shows a schematic of another prior art process for a cross border transaction where dynamic currency conversion is applied.

FIGS. 2A-2E show a schematic of a system in which dynamic currency conversion, in accordance with the present disclosure, may be performed. Each of FIGS. 2A-2E shows a stage of the dynamic currency conversion process.

FIG. 3 shows an exemplary computing device to realize a server for the intermediary shown in FIGS. 2A-2E.

FIG. 4 shows a flowchart depicting steps of a method that allows the system in accordance with FIGS. 2A-2E to perform dynamic currency conversion.

FIG. 5 shows a schematic of a server for the remitter of the system shown in FIGS. 2A-2E.

FIG. 6 shows a schematic of a server for the issuer of the system shown in FIGS. 2A-2E.

FIG. 7 shows a schematic of a server at the intermediary in the system shown in FIGS. 2A-2E.

FIG. 8 shows the server of FIG. 5 in communication with the server of FIG. 6 and the server of FIG. 7, so as to realize a system in accordance with FIGS. 2A-2E.

### DETAILED DESCRIPTION

Example embodiments will now be described more fully with reference to the accompanying drawings.

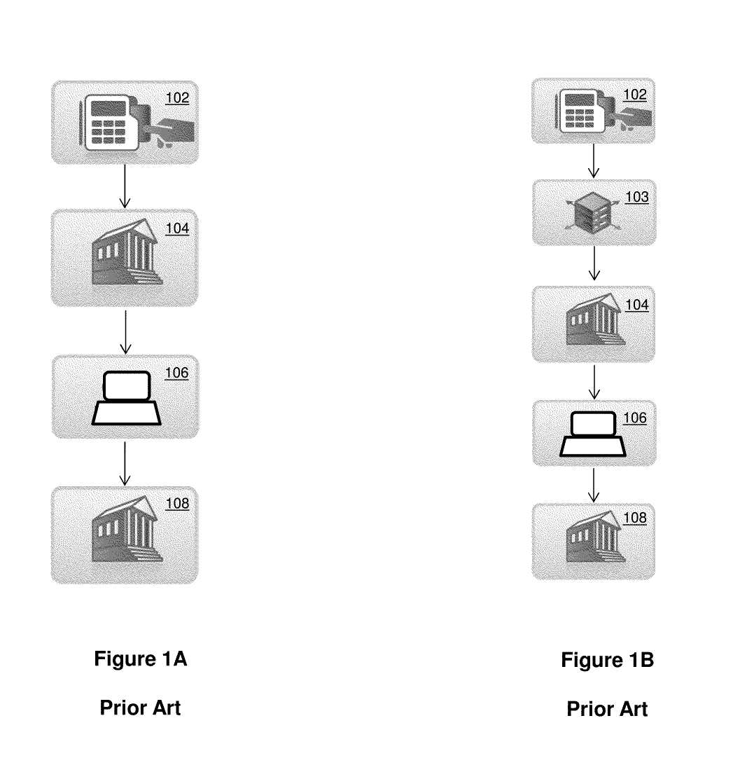

FIGS. 1A and 1B show two prior art processes to conduct a cross border transaction. As described above, a cross border transaction is one where the currency accepted by a merchant is different from the currency that is assigned to a payment instrument (such as a debit card, credit card; or a virtual debit or credit card) being used to perform a transaction with the merchant. An example of a cross border transaction would be if the merchant accepts payments in the local currency where the merchant is located (such as Vietnamese dong for a Vietnamese merchant), while the payment instrument uses a currency that depends on the location of the bank that issues the payment instrument (e.g. US dollar for an issuing bank located in the US). While the cross border transaction does not necessarily require for the transaction to occur over a geographical border (such as when a US tourist purchases goods from a local merchant in Vietnam using his credit card issued in the US), it also applies for transactions that occur across a geographical border (such as when a customer uses his Singapore issued credit card for an online purchase of goods from a US based merchant on an ecommerce website).

FIG. 1A illustrates a process for a regular cross border transaction. In the first step, a customer performs a transaction with a merchant 102 by making a purchase on a payment instrument, such as his credit card. The payment instrument is assigned a currency which is that used by an issuer 108 of the payment instrument. This assigned currency is typically the local currency where the payment instrument is issued. In this example, the issuer 108 may be a Thai bank, so that the currency assigned to the payment instrument is Thai Baht (THB). The transaction amount (i.e. the cost of the purchase) is in a currency that is accepted by the merchant 102. In this example, the merchant 102 is assumed to accept USD and the transaction amount is USD 100. Thus, the currency assigned to the payment instrument is different from a currency accepted by the merchant.

In the second step, an authorization request for the transaction is sought from a remitter 104 of the merchant 102. The remitter 104 is also known as a merchant bank or an acquirer. The authorization request is sought with the transaction details, which include an indication of the currency accepted by the merchant, the transaction amount and details of the payment instrument. The remitter 104 recognizes from the details of the payment instrument that settlement of the authorization request the remitter 104 makes to the merchant 102 is to be routed through an intermediary 106. Accordingly, the remitter 104 transmits a request to the intermediary 106 to determine whether the payment instrument has sufficient credit to pay for the transaction amount.

In the third step, the intermediary 106 receives the request from the remitter 104 and also detects, from the transaction details, that the currency assigned to the payment instrument is different from the currency accepted by the merchant 102. The intermediary 106 converts the transaction amount into the currency assigned to the payment instrument from the currency accepted by the merchant 102, at an exchange rate determined by the intermediary 106. The intermediary 106 undertakes this transaction amount conversion because the intermediary 106 earns revenue from the foreign exchange (forex) spread accounted for its determined exchange rate. The intermediary 106 then transmits the converted transaction amount to the issuer 108, along with a request to check whether the customer who holds the payment instrument on which the transaction is made has enough funds for the converted transaction amount.

In the fourth step, the issuer 108 receives the request from the intermediary 106. The issuer 108 may determine and introduce a mark-up on the converted transaction amount. The overall result may then be that the converted transaction amount is THB 3169. The issuer 108 then performs a check on whether the account to which the payment instrument is registered has sufficient credit (i.e. at least THB 3169) to pay the converted transaction amount and the mark-up, if applied. If there is sufficient credit, the remitter 104 is informed accordingly, through the intermediary 106, to pay the merchant 102, so that the transaction is approved. On the other hand, if there is insufficient credit, the remitter 104 is informed accordingly, through the intermediary 106, whereby the merchant 102 is informed that the transaction is not approved.

FIG. 1B illustrates a process for a cross border transaction where dynamic currency conversion is applied, i.e. a holder of a payment instrument has the amount of a transaction converted to its local currency (i.e. the currency assigned to the payment instrument) when the payment instrument is used to make a payment in a foreign currency.

In the first step, a customer performs a transaction with a merchant 102 by making a purchase on a payment instrument, such as his credit card. The payment instrument is assigned a currency which is that used by an issuer 108 of the payment instrument. This assigned currency is typically the local currency where the payment instrument is issued. In this example, the issuer 108 may be a Thai bank, so that the currency assigned to the payment instrument is Thai Baht (THB). The transaction amount (i.e. the amount of the purchase) is in a currency that is accepted by the merchant 102. In this example, the merchant 102 is assumed to accept USD and the transaction amount is USD 100. Thus, the currency assigned to the payment instrument is different from a currency accepted by the merchant 102.

In the second step, authorization request for the transaction is sought. A technology service provider 103 of the merchant 102 may receive the authorization request from the merchant 102 and also detect, from the transaction details, that the currency assigned to the payment instrument is different from the currency accepted by the merchant 102. The technology service provider 103 converts the transaction amount into the currency assigned to the payment instrument from the currency accepted by the party, at an exchange rate determined by the remitter 104 or by the merchant 102. The technology service provider 103 undertakes this transaction amount conversion because the forex spread may be split between the merchant 102, the technology service provider 103 and the remitter 104, so that the technology service provider 103 earns revenue from its portion of the split. The technology service provider 103 then transmits the converted transaction amount to the remitter 104. For the sake of simplicity, the converted transaction amount is THB 3169, i.e. the same as that described in the fourth step of FIG. 1A.

In the third step, authorization request for payment of the converted transaction amount (of THB 3169) is sought from a remitter 104 of the merchant 102. The remitter 104 is also known as a merchant bank or an acquirer. The authorization request for the payment is sought with the transaction details, which include an indication of the details of the payment instrument. The remitter 104 recognizes from the details of the payment instrument that settlement of the payment the remitter 104 makes to the merchant 102 is to be routed through an intermediary 106. Accordingly, the remitter 104 transmits the authorization request to the intermediary 106 to determine whether the payment instrument has sufficient credit to pay for the transaction amount.

In the fourth step, the intermediary 106 receives the authorization request from the remitter 104 and transmits the converted transaction amount to the issuer 108, along with an authorization request to check whether the account of the customer, who holds the payment instrument on which the transaction is made, has enough funds for the converted transaction amount.

In the fifth step, the issuer 108 receives the authorization request from the intermediary 106. The issuer 108 then performs a check on whether the account to which the payment instrument is registered has sufficient credit to pay the converted transaction amount. If there is sufficient credit, the remitter 104 is informed accordingly, through the intermediary 106, to pay the merchant 102, so that the transaction is approved. On the other hand, if there is insufficient credit, the remitter 104 is informed accordingly, through the intermediary 106, whereby the merchant 102 is informed that the transaction is not approved.

In contrast to FIG. 1A, the intermediary 106 of the process illustrated in FIG. 1B does not perform the transaction amount conversion, so that revenue earned from the third step of FIG. 1A is lost. While FIGS. 1A and 1B illustrate that the converted transaction amount is the same (THB 3169), this is not typically the case because the exchange rate applied by the technology service provider 103 is often not as competitive as that applied by the intermediary 106, because the intermediary 106 enjoys economies of scale from the large volume of currency conversions that the intermediary 106 undertakes. The customer (i.e. the holder of the payment instrument) may then be unhappy once he discovers that he agreed to a converted transaction amount that was performed at an uncompetitive conversion rate and choose to dispute the bill, leading to administrative cost borne by the merchant 102.

It is thus desirable to address the shortfalls of dynamic currency conversion performed by existing processes, such as the one illustrated in FIG. 1B. In the following description, various embodiments of the disclosure are described, by way of example only, with reference to the drawings, where like reference characters generally refer to the same parts throughout the different views.

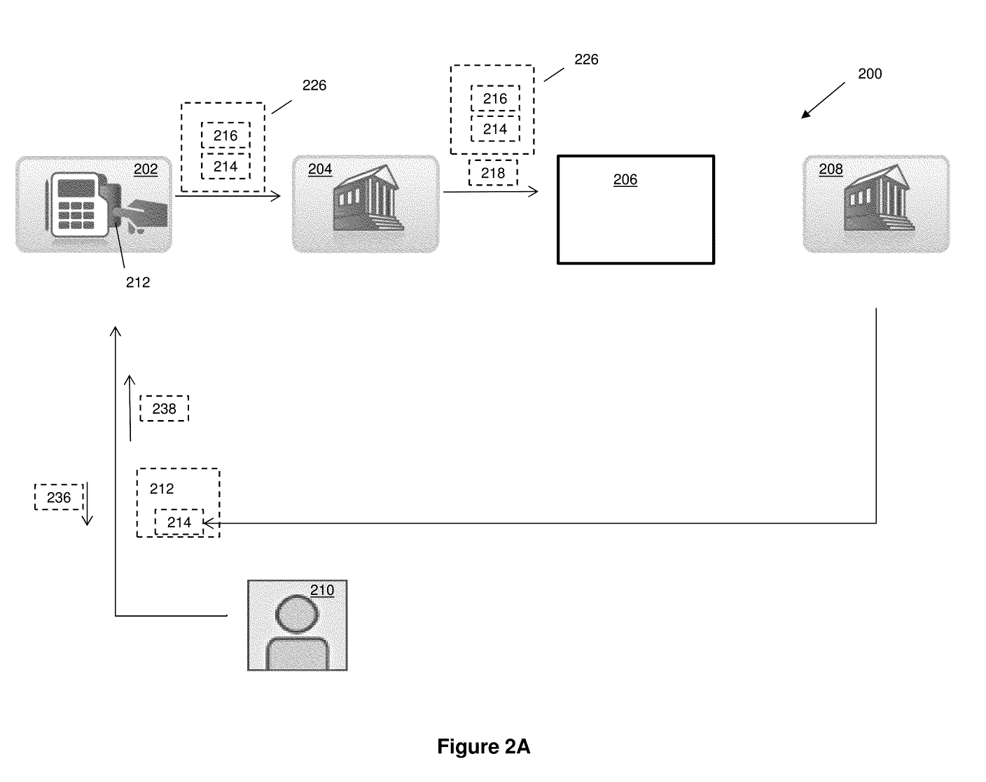

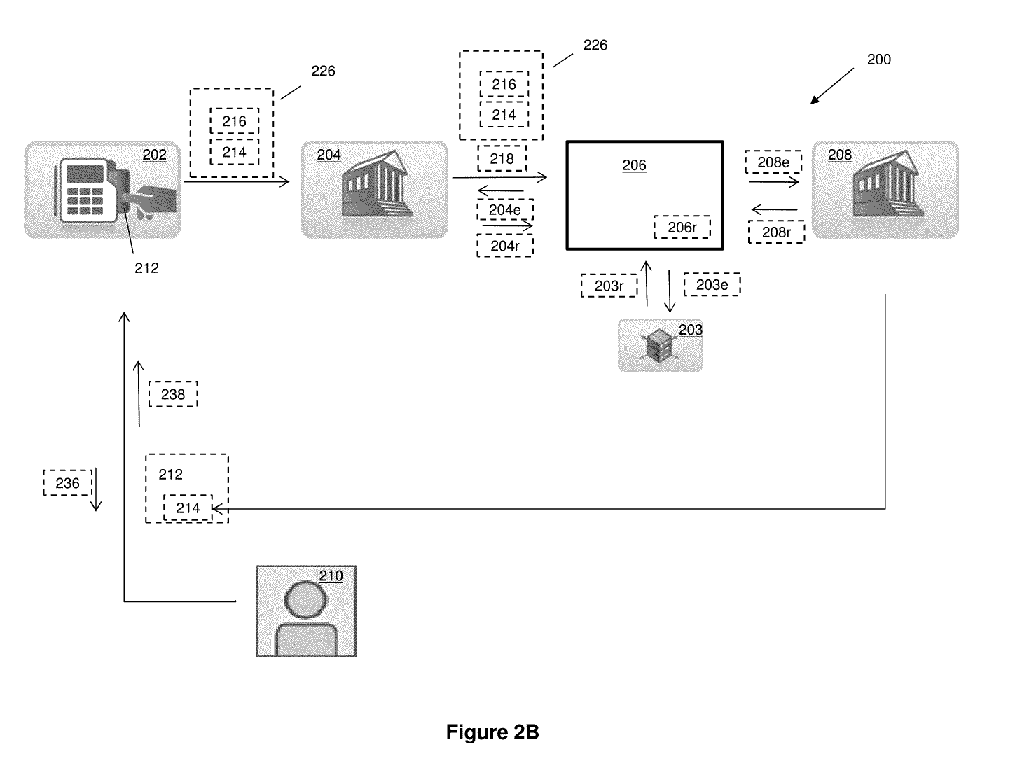

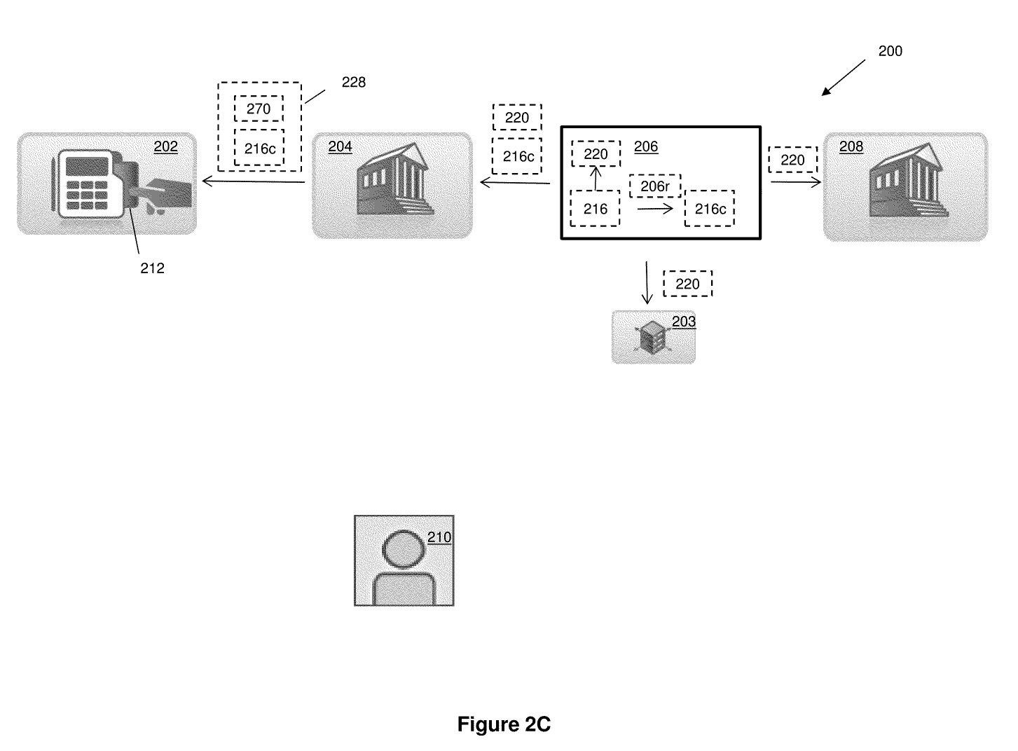

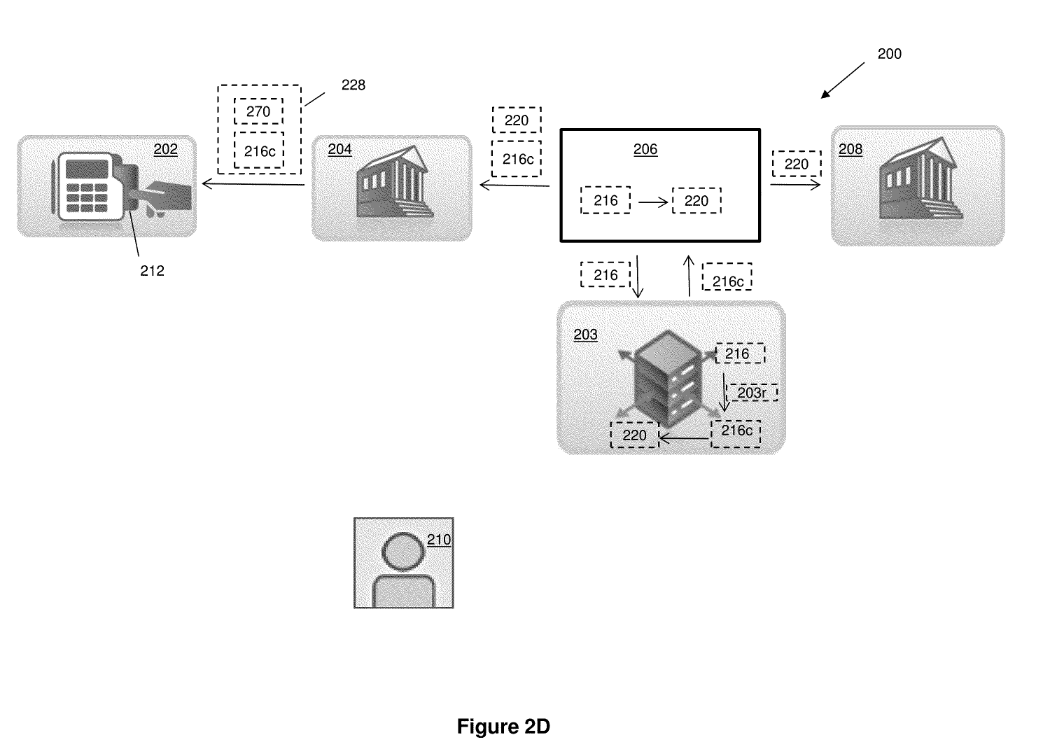

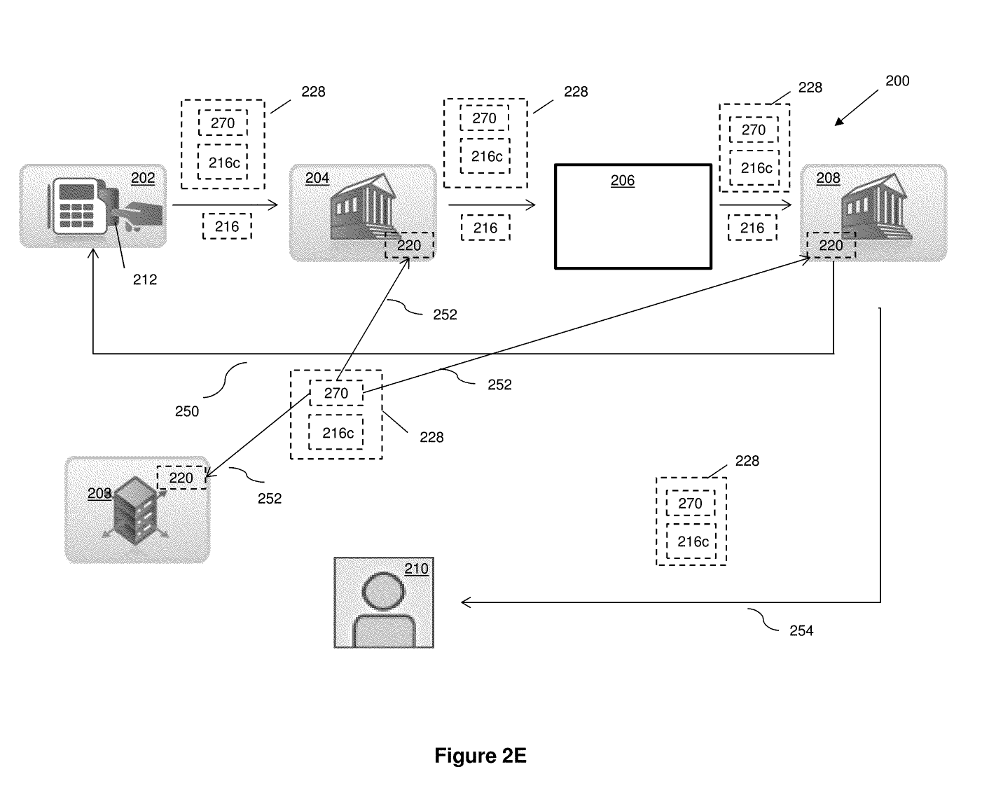

FIGS. 2A to 2E show a schematic of a system 200 in which dynamic currency conversion may be performed. Each of FIGS. 2A to 2E shows a respective stage of the dynamic currency conversion method. The system 200 involves similar participants to those described in FIG. 1A, so that the system 200 includes a party 202, a remitter 204, an intermediary 206 and an issuer 208. However, in addition, the system 200 optionally includes a technology service provider 203 (see FIGS. 2B to 2E). The system 200 supports a transaction which is initiated at the party 202 and concludes after the relevant participants are paid, wherein dynamic currency conversion is performed as part of the transaction.

The party 202 is synonymous to the merchant 102 of FIG. 1A and thus includes any one or more of a merchant, distributor or vendor. The party 202 may be a business offering goods or services. The goods may include tangible products (such as clothes and groceries) and intangible products (such as software applications) for installation into a computing platform (such as a mobile phone), or services.

The remitter 204 is a participant that seeks authorization from the issuer 208 via the intermediary 206 on whether the party 202 meets the criteria that allows for the party 202 to use the infrastructure provided by the financial services provider to which the intermediary 206 belongs. The remitter 204 pays the transaction that a customer 210 makes with the party 202, after the transaction is approved. The remitter 204 may include any one or more of a bank, a telecommunication service provider or a financial institution.

The technology service provider 203, when prompted, provides a currency conversion rate at which currency conversion occurs to the intermediary 206 and, when selected, performs the currency conversion at this currency conversion rate. The remitter 204 and the issuer 208 may also provide, when prompted, a currency conversion rate to the intermediary 206 and, when selected, provide the currency conversion at this determined currency rate upon selection.

A server network, to which the intermediary 206 belongs, provides an architecture that allows dynamic currency conversion. The intermediary 206 may provide the currency rate at which currency conversion occurs and provides the currency conversion at this determined currency rate. The intermediary 206 may determine this currency rate from currency purchase prices from the financial services provider, to which the intermediary 206 belongs, trading at wholesale money markets. The intermediary 206 may also determine this currency rate from a currency conversion service provider, wherein the currency conversion is then performed by the currency conversion service provider providing the selected currency conversion rate. The currency conversion service provider may include the remitter 204, the issuer 208 and a third party, such as the technology service provider 203.

The issuer 208 provides payment instruments, such as a credit or a debit card, for holders (i.e. the customer 210) of such instruments to make purchases from the party 202. The issuer 208 typically provides the owner of such payment instruments a credit line (especially in the case of the credit card) against which is checked whether there are sufficient funds to pay for a transaction initiated by the holder of a payment instrument. In this context, the issuer 208 can be understood to be the bank of the customer 210. In the following description, the customer 210 and the holder are used interchangeably.

The initiation of a transaction, through the purchase of a good or a service, may be performed electronically, such as over the Internet, with no need for the customer 210 to physically visit the party 202. The party 202 also receives immediate payment for the goods or services, not from the customer 210, but rather from the remitter 204. Accordingly, the party 202 may include one or more computer terminals/servers to process such an electronic purchase. The remitter 204 is paid by the intermediary 206, which is in turn paid by the issuer 208.

In FIG. 2A, the customer 210 uses a payment instrument 212 to pay for a transaction initiated at the party 202. The payment instrument 212 is assigned a currency 214 that is determined by the issuer 208 of the payment instrument 212. Using the same assumptions of FIGS. 1A and 1B, the issuer 208 may be a Thai bank, so that the currency 214 assigned to the payment instrument 212 is Thai Baht (THB).

The party 202 then sends to the remitter 204 the transaction details 226, which include the transaction amount 216, the payment instrument 212 details and the currency 214 assigned to the payment instrument 212. There is also other data in the transaction details 226 which is relevant to the transaction, such as the party 202 name, the party 202 address and the time at which the transaction is initiated. The transaction details 226 of the transaction may include data that when processed provides information on the amount paid for the goods or services purchased from the party 202 and also a list of the goods or services purchased from the party 202. The transaction amount 216 is sent to the remitter 204 in the currency accepted by the party 202. Using the same assumptions of FIGS. 1A and 1B, the party 202 accepts USD and the transaction amount is USD 100.

It is determined that the currency 214 assigned to the payment instrument 212, on which the transaction with the party 202 is made, is different from the currency accepted by the party 202. This determination is performed by the remitter 204. The determination can also be performed by the party 202, through a third-party technology service provider that is not illustrated in FIG. 2A, in which case the transaction details 226 would also indicate that such a currency difference determination has been performed by the party 202. On the other hand, this determination is preferably directly performed by the party 202. After it is determined that there is a difference between the currency 214 assigned to the payment instrument 212 and the currency accepted by the party 202, the party 202 is informed about this difference through, for example, a POS terminal. The party 202 then verbally asks the customer 210 whether he/she would like to proceed with the payment of the transaction in the currency 214 assigned to the payment instrument 212 (illustrated using reference numeral 236). If the customer 210 wants to proceed with the transaction in the currency 214 assigned to the payment instrument 212 (e.g. THB), the customer 210 provides a verbal consent (illustrated using reference numeral 238) to the party 202. The party 202 then uses the POS terminal to indicate the party 202 consent to the remitter 204, which causes the remitter 204 to send the transaction details 226 to the intermediary 206, along with a request 218 to convert the transaction amount 216 into the currency 214 assigned to the payment instrument 212, so that the system 200 is able to provide a dynamic currency conversion service, i.e. the customer 210 is presented the transaction amount 216 in the currency 214 assigned by the issuer 208, rather than the amount in the currency accepted by the party 202. The transmissions between the remitter 204 and the intermediary 206 can be communicated in ISO message format. For example, the payment instrument 212 may be provided with an identifier configured to be processed by the intermediary 206 that causes the intermediary 206 to provide a conversion rate at which the transaction amount 216 is converted from the currency accepted by the party 202 to the currency 214 assigned to the payment instrument 212. Such an identifier may be coded in an ISO message format, for example ISO 8583. When the payment instrument 212 is used to pay a transaction initiated at the party 202, the identifier becomes part of the transaction details 226 that is provided to the intermediary 206. The identifier may be embedded in an ISO 8583 compliant message that when processed by the intermediary 206 causes the intermediary 206 to provide the party 202 with the transaction amount 216 in the currency 214 assigned to the payment instrument 212 and to have the party 202 obtain consent from the customer 210 for the converted transaction amount, both described in further detail in FIG. 2B below.

In FIG. 2B, the intermediary 206 may send enquiries 204e, 208e and/or 203e to one or more currency conversion providers for currency conversion rates, and obtain one or more currency conversion rates from the plurality of currency conversion service providers. As described above, the plurality of currency conversion service providers may comprise the remitter 204 providing a currency conversion rate 204r, the issuer 208 providing a currency conversion rate 208r and one or more technology service providers 203 providing a currency conversion rate 203r. For simplicity, only one technology service provider 203 is shown in FIG. 2B, although more than one technology service provider 203 may be involved in providing the currency conversion rate 203r. Alternatively, the intermediary 206 may obtain the currency conversion rate 206r itself, without using the plurality of currency conversion service providers.

FIG. 2C shows an embodiment where the currency conversion rate 206r provided by the intermediary 206 is selected.

The intermediary 206 converts the transaction amount 216 into the currency assigned to the payment instrument 212, at the selected currency conversion rate 206r, from the currency accepted by the party 202. The converted transaction amount 216c is then returned to the remitter 204, in response to the request 218 (see FIG. 2A). The converted transaction amount 216c may be THB 3092. A monetary value 220 is then determined, which is to be provided to one or more participants of the transaction to be kept as revenue. For instance, the monetary value 220 kept by the intermediary 206 may be from performing the currency conversion. The monetary value 220 is also transmitted to the remitter 204, along with the converted transaction amount 216c. The monetary value 220 may also be transmitted to the technology service provider 203 and the issuer 208.

The monetary value 220 is dependent on the converted currencies. The monetary value 220 may be a fixed percentage that depends on the currency being converted, i.e. an amount that is based on the type of currency being converted, as opposed to being a factor considered when calculating forex spread. This monetary value 220 may be a value that is agreed upon between the one or more participants of the transaction, such as: between the remitter 204 and the intermediary 206; and between the issuer 208 and the intermediary 206. The agreement may be updated annually, or on an agreed upon time frame. The monetary value 220 may also be based on a tiered structure where a currency conversion rate varies based on the quantum of funds (i.e. transaction amount) being transacted, for example, being 2% for a transaction amount within USD100-999, whereas 1.85% for a transaction amount within USD1000-9999. Therefore, this monetary value 220 is independent of currency fluctuations that may occur due to demand and supply of the currencies being converted.

In this exemplary embodiment, having the intermediary 206 undertake the dynamic currency conversion centralizes the currency conversion process and improves efficiency of currency conversion. Further, as the intermediary 206 earns revenue from performing the currency conversion using its currency conversion rate 206r, forwarding of the monetary value 220 to the one or more of the participants of the remitter 204, the technology service provider 203 and/or the issuer 208 serves as compensation for not undertaking the dynamic currency conversion. It will also be appreciated that the amount of the monetary value 220 received by the issuer 208, the remitter 204 and the technology service provider 203 may not necessarily be the same as the amount of the monetary value 220 received by the intermediary 206. Similarly, the monetary value 220 received by each of the issuer 208, the remitter 204 and the technology service provider 203 may not necessarily be the same.

FIG. 2D shows an embodiment where the currency conversion rate 203r provided by the technology service provider 203 is selected.

The intermediary 206 forwards the transaction amount 216 to technology service provider 203. The technology service provider 203 converts the transaction amount 216 into the currency assigned to the payment instrument 212, at the selected currency conversion rate 203r, from the currency accepted by the party 202. The converted transaction amount 216c is then returned to the intermediary 206. The intermediary 206 then subsequently forwards the converted transaction amount 216c to the remitter 204, in response to the request 218 (see FIG. 2A). The converted transaction amount 216c may also be THB 3092. Similar to the scenario of FIG. 2C, a monetary value 220 is then determined at the intermediary 206, which is to be provided to one or more participants of the transaction to be kept as revenue. For instance, the monetary value 220 kept by the technology service provider 203 may be from performing the currency conversion. The intermediary 206 may obtain the monetary value 220 from facilitating for the currency conversion to be performed by the technology service provider 203. The monetary value 220 is transmitted to the remitter 204, along with the converted transaction amount 216c. The monetary value 220 may also be transmitted to the issuer 208.

As described with reference to FIG. 2C, the monetary value 220 is dependent on the converted currencies. The monetary value 220 may be a fixed percentage that depends on the currency being converted, i.e. an amount that is based on the type of currency being converted, as opposed to being a factor considered when calculating forex spread. This monetary value 220 may be a value that is agreed upon between the one or more participants of the transaction, such as: between the remitter 204 and the intermediary 206; and between the issuer 208 and the intermediary 206. The agreement may be updated annually, or on an agreed upon time frame. The monetary value 220 may also be based on a tiered structure where a currency conversion rate varies based on the quantum of funds (i.e. transaction amount) being transacted, for example, being 2% for a transaction amount within USD100-999 whereas 1.85% for a transaction amount within USD 1000-9999. Therefore, this monetary value 220 is independent of currency fluctuations that may occur due to demand and supply of the currencies being converted.

As the technology service provider 203 earns revenue from performing the currency conversion using its currency conversion rate 203r, the providing of the monetary value 220 from the intermediary 206 to the one or more of the participants of the remitter 204 and/or the issuer 208 serves as compensation for not undertaking the dynamic currency conversion. It will also be appreciated that the amount of the monetary value 220 received by the issuer 208, the remitter 204 and the technology service provider 203 may not necessarily be the same as the amount of the monetary value 220 received by the intermediary 206. Similarly, the monetary value 220 received by each of the issuer 208, the remitter 204 and the technology service provider 203 may not necessarily be the same.

FIGS. 2C and 2D also show that confirmation of the customer 210 agreement to paying the transaction in the currency 214 assigned to the payment instrument 212 is then sought. To facilitate this confirmation, the remitter 204 provides to the party 202 a total 228 of the converted transaction amount 216c and the monetary value 220, the total 228 being in the currency 214 assigned to the payment instrument 212. Approval is sought from the party 202 of the total 228 amount, where a breakdown of the converted transaction amount 216c and each of the monetary values 220 is not provided to the party 202. Using the same assumptions of FIGS. 1A and 1B, the total 228 would be THB 3169, which encompasses a currency conversion cost 270 that includes a total of each of the monetary values 220 (i.e. a summation of the monetary values 220 provided to one or more participants of the transaction). The currency conversion cost 270 would be THB 77 (THB 3169−THB 3092). Approval from the customer 210 (i.e. the holder of the payment instrument 212) for this total 228 is then sought by the party 202, which may be done by the POS terminal at the party 202 (i.e. the merchant) indicating that the equivalent amount of the transaction of USD100 is THB 3169, as described with reference to FIG. 2E.

In FIG. 2E, the customer 210 approves, for example verbally, the total 228 at the party 202 terminal. Upon approval, the party 202 will use the system 200 to initiate a fund check, i.e. whether an account that the customer 210 has with the issuer 208 for the payment instrument 212 has enough money to pay for the total 228. A message, which may be in the form of an authorization request, is sent from the party 202 to the remitter 204 with an indication of the amount of the total 228 in the currency 214 assigned to the payment instrument 212. The message also includes information on the transaction amount 216 in the currency accepted by the party 202.

The remitter 204 receives the message and passes it on to the intermediary 206 for routing to the issuer 208. The issuer 208, upon receiving this message, will perform a check to determine if the account against which the payment instrument 212 is registered has sufficient funds to cover the total 228 in the currency 214 assigned to the payment instrument 212. When it is determined that there is sufficient funds, the issuer 208 approves the total 228 converted amount (being THB 3169 in this example), whereby the party 202 will receive a message that the transaction is completed. The completion of the transaction (represented by the arrow 250) has the issuer 208 pay the total 228 to the remitter 204 via the intermediary 206. During this process, the monetary value 220 is provided (represented by the arrow 252), for example by the intermediary 206, to the remitter 204, the issuer 208 and/or the one or more technology service provider 203 to be kept as revenue. The customer 210 will then, in due course (represented by the arrow 254), be billed for the total 228 in the currency 214 assigned to the payment instrument 212.

When the issuer 208 receives the total 228 of the amount to be billed to the customer 210, in the currency 214 assigned to the payment instrument 212, it also receives the transaction amount 216 in the currency accepted by the party 202 (i.e. the transaction amount in merchant currency). The receiving of this transaction amount 216 in the merchant currency allows the issuer 208 to identify that dynamic currency conversion occurred in accordance with FIGS. 2A to 2E, as opposed to dynamic currency conversion that occurred in accordance with FIG. 1B, where the issuer 108 does not receive the transaction amount in the currency accepted by the merchant 102. This may allow the issuer 208 to gather statistics on market acceptance of dynamic currency conversion that occurs in accordance with FIGS. 2A to 2E.

Use of the term ‘server’ herein may be understood to mean a single computing device or a plurality of interconnected computing devices which operate together to perform a particular function. That is, the server may be contained within a single hardware unit or be distributed among several or many different hardware units.

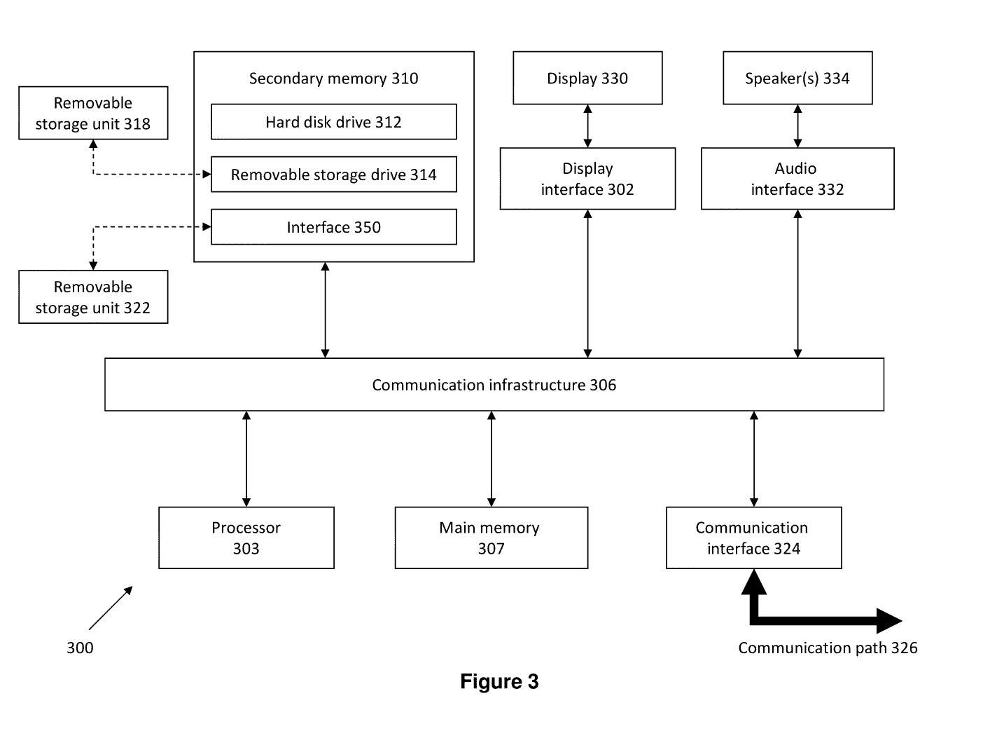

FIG. 3 shows an exemplary computing device 300, to realize a server for the intermediary 206 shown in FIGS. 2A to 2E. The following description of the computing device 300 is provided by way of example only and is not intended to be limiting. Therefore, one or more elements/components of the computing device 300 may be omitted. Also, one or more elements/components of the computing device 300 may be combined together. Additionally, one or more elements/components of the computing device 300 may be split into one or more component parts.

With reference to FIG. 3, the exemplary computing device 300 includes a processor 303 for executing software routines. Although a single processor is shown for the sake of clarity, the computing device 300 may also include a multi-processor system. The processor 303 is connected to a communication infrastructure 306 for communication with other components of the computing device 300. The communication infrastructure 306 may include, for example, a communications bus, cross-bar, or network.

The computing device 300 further includes a main memory 307, such as a random access memory (RAM), and a secondary memory 310. The secondary memory 310 may include, for example, a hard disk drive 312 and/or a removable storage drive 314, which may include a floppy disk drive, a magnetic tape drive, an optical disk drive, or the like. The removable storage drive 314 reads from and/or writes to a removable storage unit 318 in a well-known manner. The removable storage unit 318 may include a floppy disk, magnetic tape, optical disk, or the like, which is read by and written to by removable storage drive 314. As will be appreciated by persons skilled in the relevant art(s), the removable storage unit 318 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 350. Examples of a removable storage unit 322 and interface 350 include a program cartridge and cartridge interface (such as that found in video game console devices), a removable memory chip (such as an EPROM or PROM) and associated socket, and other removable storage units 322 and interfaces 350 which allow software and data to be transferred from the removable storage unit 322 to the computing device 300.

The computing device 300 also includes at least one communication interface 324. The communication interface 324 allows software and data to be transferred between computing device 300 and external devices via a communication path 326. In various implementations, the communication interface 324 permits data to be transferred between the computing device 300 and a data communication network, such as a public data or private data communication network. The communication interface 324 may be used to exchange data between different computing devices 300 which such computing devices 300 form part of an interconnected computer network. Examples of a communication interface 324 can include a modem, a network interface (such as an Ethernet card), a communication port, an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage unit 318, removable storage unit 322, a hard disk installed in hard disk drive 312, or a carrier wave carrying software over communication path 326 (wireless link or cable) to communication interface 324. A computer readable medium can include magnetic media, optical media, or other recordable media, or media that transmits a carrier wave or other signal. These computer program products are devices for providing software to the computing device 300. Computer readable storage medium refers to any non-transitory tangible storage medium that provides recorded instructions and/or data to the computing device 300 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 307 and/or secondary memory 310. Computer programs can also be received via the communication interface 324. Such computer programs, when executed, enable the computing device 300 to perform one or more steps that initiate the dynamic currency conversion for cross border transactions between the customer 210 and the party 202, as described above with reference to FIG. 2A-2E. The computer programs, when executed, enable the processor 303 to facilitate the dynamic currency conversion for cross border transactions between the customer 210 and the party 202. Accordingly, such computer programs may represent controllers of the computing device 300.

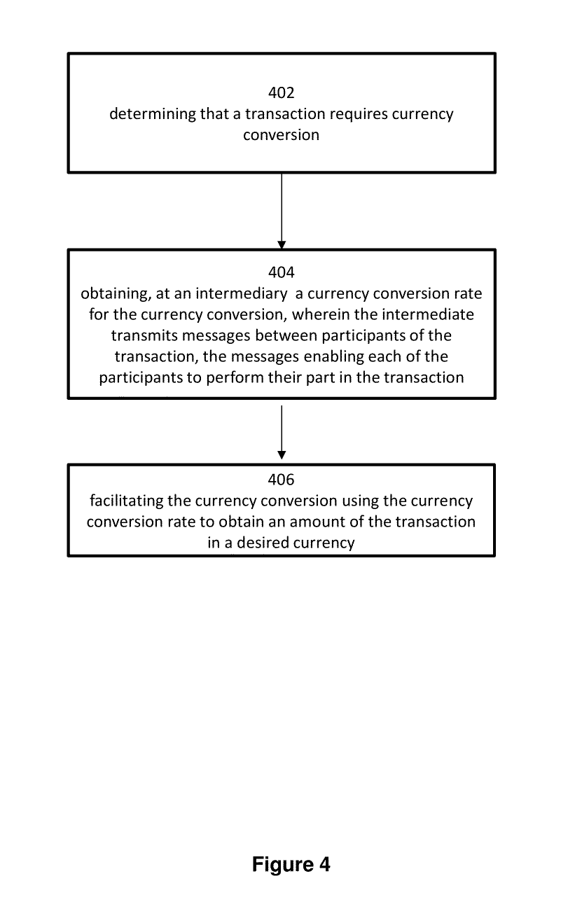

Software may be stored in a computer program product and loaded into the computing device 300 using the removable storage drive 314, the hard disk drive 312, or the interface 350. Alternatively, the computer program product may be downloaded to the computing device 300 over the communications path 326. The software, when executed by the processor 303, causes the computing device 300 to perform the necessary operations to execute the method as shown in FIG. 4.

FIG. 4 shows a flowchart depicting steps of a method that allows the system 200 of FIGS. 2A-2E to perform dynamic currency conversion. With reference to FIG. 3, the method may be implemented as software and stored in a non-transitory fashion in the secondary memory 310 or the removable storage units 318, 322 of the computing device 300. The software is executable by the processor 303 of the computing device 300. The method allows for dynamic currency conversion. The method includes the following steps as detailed below and described with reference to FIGS. 2A-2E.

In step 402, it is determined that a transaction requires currency conversion. That is, it is determine that a currency 214 assigned to a payment instrument 212, on which a transaction with a party 202 is made, is different from a currency accepted by the party 202.

In step 404, a currency conversion rate is obtained at an intermediary 206. The intermediary 206 transmits messages between participants of the transaction, wherein the messages enable each of the participants to perform their part in the transaction. In step 406, the intermediary 206 facilitates the currency conversion using the currency conversion rate to obtain an amount of the transaction in a desired currency. As described herein, the used currency conversion rate may be provided by the intermediary 206 itself, or one of the remitter 204, one or more technology service providers 203 (not shown in FIG. 2D) and the issuer 208

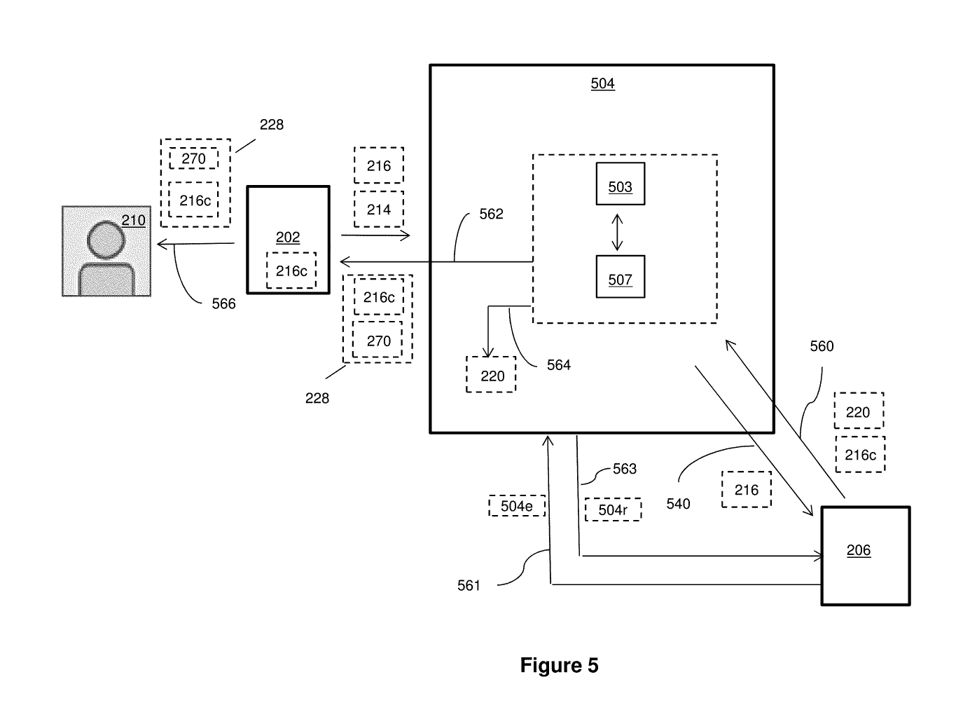

FIG. 5 shows a schematic of a server 504 for the remitter 204 of the system 200 shown in FIGS. 2A-2E. The server 504 includes at least one processor 503 and at least one memory 507. Other components that the server 504 may have are omitted for the purposes of simplicity.

Computer program code within the at least one memory 507 is configured, in one exemplary implementation, to have the at least one memory 507, with the at least one processor 503, cause the remitter server 504 to determine that a currency 214 assigned to a payment instrument 212, on which the transaction with the party 202 is made, is different from a currency accepted by the party 202. The computer code within the at least one memory 507 then configures the at least one processor 503 to cause the remitter server 504 to transmit 540 the transaction amount 216 for conversion into the currency 214 assigned to the payment instrument 212 from the currency accepted by the party 202 (i.e. to obtain the converted transaction amount 216c). In one implementation, such as the one shown in FIGS. 2A to 2E, the server 504 transmits 540 the transaction amount 216 to the intermediary 206. Subsequently, the computer code within the at least one memory 507 configures the at least one processor 503 to cause the remitter server 504 to receive 560 the converted transaction amount 216c and a monetary value 220. The server 504 provides 562 a holder 210 of the payment instrument 212 with a total 228 of the converted transaction amount 216c and the currency conversion cost 270 for approval, the total 228 being in the currency 214 assigned to the payment instrument 212. The computer code within the at least one memory 507 configures the at least one processor 503 to cause the remitter server 504 to keep 564 the monetary value 220 as revenue for the remitter 204, which occurs after completion of the transaction.

The computer code within the at least one memory 507 may be configured to, with the at least one processor 503, cause the remitter server 504 to provide 562 the total 228 of the converted transaction amount 216c and the currency conversion cost 270 for the approval of the holder 210 of the payment instrument through the party 202 (depicted using the arrow 566). The at least one memory 507 and the at least one processor 503 may also be configured to receive 561 a currency conversion rate enquiry 504e from the intermediary 206 and provide 563 a currency conversion rate 504r to the intermediary 206.

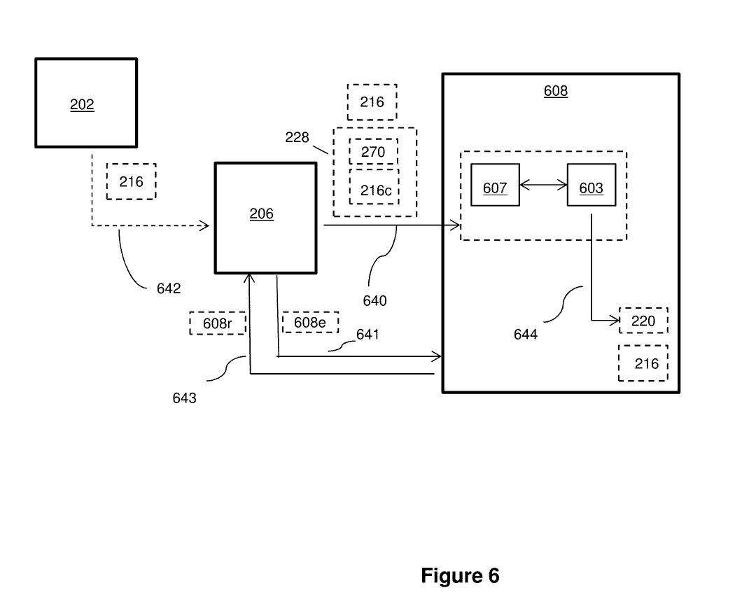

FIG. 6 shows a schematic of a server 608 for the issuer 208 of a payment instrument 212 on which a transaction with a party 202 is made, the issuer 208 being part of the system 200 shown in FIGS. 2A-2E. The server 608 includes at least one processor 603 and at least one memory 607. Other components that the server 608 may have are omitted for the purposes of simplicity.

Computer program code within the at least one memory 607 is configured to have the at least one memory 607, with the at least one processor 603, cause the server 608 at least to receive 641 a currency conversion rate enquiry 608e from the intermediary 206 and provide 643 a currency conversion rate 608r to the intermediary 206.

Further, computer program code within the at least one memory 607 is configured to have the at least one memory 607, with the at least one processor 603, which causes the server 608 at least to: receive 640, when a currency 214 assigned to the payment instrument 212 is determined to be different from a currency accepted by the party 202, the transaction amount 216 in the currency accepted by the party 202. In one implementation, such as the one shown in FIGS. 2A to 2E, the transaction amount 216 is received 640 from the intermediary 206, which originates 642 from the party 202 (through the remitter 204, with the communication involving the remitter 204 not shown in FIG. 6 for the sake of simplicity). The computer code within the at least one memory 607 is also configured to, with the at least one processor 603, cause the server 608 to receive 640 a total 228 of the transaction amount 216 converted into the currency 214 assigned to the payment instrument 212 (i.e. the converted transaction amount 216c) and the currency conversion cost 270 comprising a monetary value 220. The computer code within the at least one memory 607 configures the at least one processor 603 to cause the issuer server 608 to keep 644 the monetary value 220 as revenue for the issuer 208, which occurs after completion of the transaction. Subsequently (not shown), the computer code within the at least one memory 607 is configured to, with the at least one processor 603, cause the server 608 to pay the remitter server 504 the total 228 (of the converted transaction amount 216c and the currency conversion cost 270) in the currency 214 assigned to the payment instrument 212.

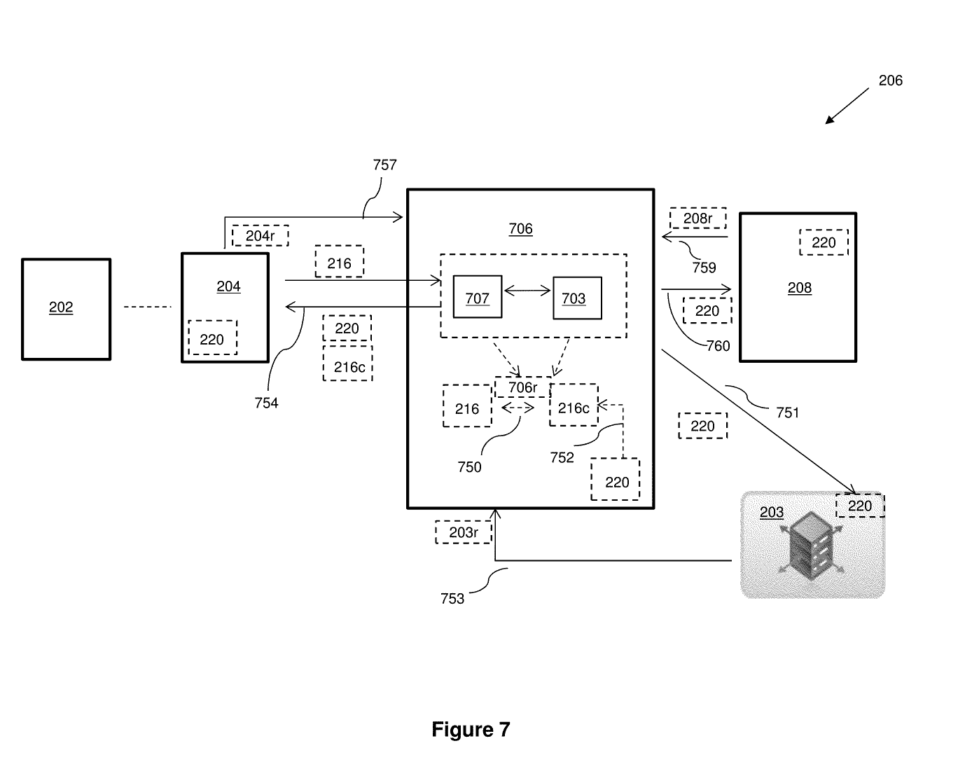

FIG. 7 shows a schematic of a server 706 for the intermediary 206 shown in the system 200 of FIGS. 2A-2E. As described with respect to FIGS. 2A to 2E, the intermediary 206 transmits messages between participants of the transaction which requires currency conversion, the messages enabling each of the participants to perform their part in the transaction.

The server 706 includes at least one processor 703 and at least one memory 707. Other components that the server 706 may have are omitted for the purposes of simplicity.

Computer program code within the at least one memory 707 is configured to have the at least one memory 707, with the at least one processor 703, cause the server 706 at least to obtain a currency conversion rate for the currency conversion; and facilitate the currency conversion using the currency conversion rate to obtain an amount of the transaction in a desired currency. This may be achieved by having the server 706 respectively obtain 757, 759 and/or 753 currency conversion rates 204r, 208r and 203r from the remitter 204, the issuer 208 and the technology service provider 203. It is also possible for the intermediary 206 to obtain the currency conversion rate 706r provided by the intermediary 206 itself. The server 706 selects one currency conversion rate from the obtained currency conversion rates 204r, 208r, 203r and/or 706r to facilitate the currency conversion 750. In the embodiment shown in FIG. 7 the currency conversion rate 706r is selected and thus the currency conversion is performed 750 at the server 706, to convert the transaction amount 216 from a currency accepted by the party 202 into a currency 214 assigned to the payment instrument 212 (i.e. the converted transaction amount 216c). The computer code within the at least one memory 707 is then configured to, with the at least one processor 703, cause the server 706 to determine 752 a monetary value 220 that is dependent on the converted currencies, and transmit 754 the monetary value 220 to the remitter 204 to be kept as revenue to the remitter 204. The server 706 may also transmit 760, 751 the monetary value 220 to be kept as revenue by the issuer 208 and the technology service provider 203 respectively. The server 706 may transmit 754 the monetary value 220, together with the converted transaction amount 216c to the remitter 204 after completion of the transaction.

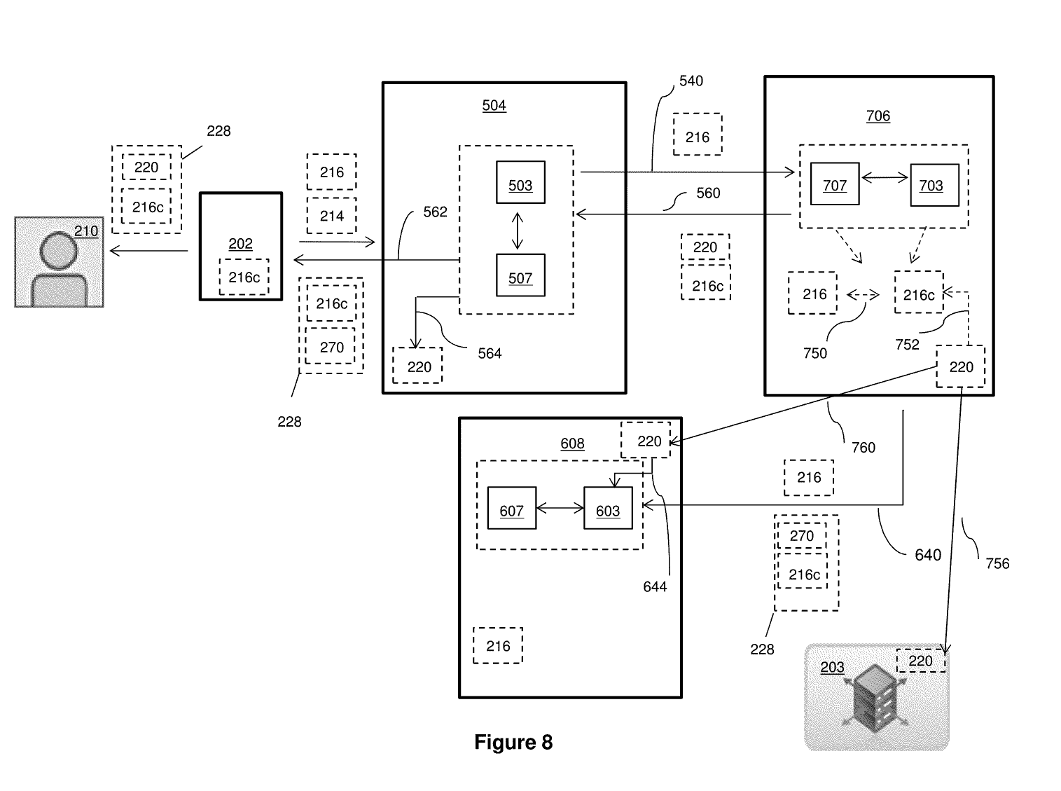

FIG. 8 shows a schematic of the server 504 of FIG. 5 in communication with the server 608 of FIG. 6 and the server 706 of FIG. 7, so as to realize a system 200, which is also shown in FIGS. 2A to 2E. The server 504 includes at least one processor 503 and at least one memory 507, the server 608 includes at least one processor 603 and at least one memory 607, the server 706 includes at least one processor 703 and at least one memory 707. Other components that the servers 504, 608 and 706 may have are omitted for the purposes of simplicity.

Computer program code within the at least one memory 507 is configured to have the at least one memory 507, with the at least one processor 503, cause the remitter server 504 to determine that a currency 214 assigned to a payment instrument 212, on which the transaction with the party 202 is made, is different from a currency accepted by the party 202. The computer code within the at least one memory 507 then configures the at least one processor 503 to cause the remitter server 504 to transmit 540 the transaction amount 216 for conversion into the currency 214 assigned to the payment instrument 212 from the currency accepted by the party 202. In one implementation, such as the one shown in FIGS. 2A to 2E, the server 504 transmits 540 the transaction amount 216 to the intermediary server 706. Subsequently, the computer code within the at least one memory 507 configures the at least one processor 503 to cause the remitter server 504 to receive 560 a monetary value 220. The server 504 also provides a holder 210 of the payment instrument 212 with a total 228 of the converted transaction amount 216c and the currency conversion cost 270 for approval, the total 228 being in the currency 214 assigned to the payment instrument 212. The computer code within the at least one memory 507 configures the at least one processor 503 to cause the remitter server 504 to keep 564 the monetary value 220 as revenue for the remitter 204, after the transaction is completed.

The computer code within the at least one memory 507 may be further configured to, with the at least one processor 503, cause the remitter server 504 to provide the total 228 of the converted transaction amount 216c and the currency conversion cost 270 for the approval of the holder 210 of the payment instrument through the party 202.

Turning to the server 706 for the intermediary 206, computer program code within the at least one memory 707 is configured to have the at least one memory 707, with the at least one processor 703, obtain currency conversion rates from the remitter 204, the issuer 208 the technology service provider 203, or the intermediary 206 itself. The server 706 selects one currency conversion rate from the obtained currency conversion rates to facilitate the currency conversion.

The intermediary 206 further transmits messages between participants of the transaction which requires currency conversion, the messages enabling each of the participants to perform their part in the transaction. For example, in this embodiment where the selected currency conversion rate is provided by the intermediary 206 and the currency conversion is performed at the intermediary server 706, computer program code within the at least one memory 707 is configured to have the at least one memory 707, with the at least one processor 703, cause the server 706 at least to convert 750 the transaction amount 216 from a currency accepted by the party 202 into a currency 214 assigned to the payment instrument 212 (i.e. the converted transaction amount 216c), when the currency accepted by the party 202 is determined to be different from the currency 214 assigned to the payment instrument 212. The computer code within the at least one memory 707 is then configured to, with the at least one processor 703, cause the server 706 to determine 752 a monetary value 220 dependent on the converted currencies, and transmit 754 the converted transaction amount 216c to the server 504, along with the monetary value 220. The computer code within the at least one memory 707 is then configured to, with the at least one processor 703, cause the server 706 to transmit 756 the monetary value 220 to the technology service provider 203 and transmit 760 the monetary value 220 to the server 608. This monetary value 220 is kept as revenue by the server 504, the server 608 and the technology service provider 203, as compensation for the server 706 performing the currency conversion. The monetary value 220 is kept as revenue after the transaction is completed.

Turning to the server 608 for the issuer 208, computer program code within the at least one memory 607 is configured to have the at least one memory 607, with the at least one processor 603, cause the server 608 at least to: receive 640, when a currency 214 assigned to the payment instrument 212 is determined to be different from a currency accepted by the party 202, the transaction amount 216 in the currency accepted by the party 202. In one implementation, such as the one shown in FIGS. 2A to 2E, the transaction amount 216 is received 640 from the server 706 for the intermediary 206. The computer code within the at least one memory 607 is also configured to, with the at least one processor 603, cause the server 608 to receive 640 a total 228 of the converted transaction amount 216c and the currency conversion cost 270 comprising the monetary value 220 that is dependent on the converted currencies. Subsequently (not shown), the computer code within the at least one memory 607 is configured to, with the at least one processor 603, cause the server 608 to pay the remitter server 504 the total 228 (of the converted transaction amount 216c and the currency conversion cost 270) in the currency 214 assigned to the payment instrument 212, via the intermediary server 706. The computer code within the at least one memory 607 configures the at least one processor 603 to cause the issuer server 608 to keep 644 the monetary value 220 as revenue for the issuer 208, after the transaction is completed.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

It should also be appreciated that the functions and/or steps and/or operations described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

Further, it should be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In addition, the exemplary embodiments herein are only examples, and are not intended to limit the scope, applicability, operation, or configuration of the disclosure in any way. It will be further appreciated by a person skilled in the art that numerous variations and/or modifications may be made to one or more of the above-described embodiments without departing from the spirit or scope of the disclosure as broadly described in the appended claims. The above-described embodiments are, therefore, to be considered in all respects to be illustrative and not restrictive.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

1. A method for dynamic currency conversion, the method comprising:
determining that a transaction requires currency conversion;
obtaining at an intermediary a currency conversion rate for the currency conversion, wherein the intermediary transmits messages between participants of the transaction, the messages enabling each of the participants to perform their part in the transaction; and
facilitating the currency conversion using the currency conversion rate to obtain an amount of the transaction in a desired currency.

2. The method of claim 1, wherein the currency conversion rate is selected from a plurality of rates each provided by a currency conversion service provider.

3. The method of claim 2, wherein the currency conversion is performed by the currency conversion service provider providing the selected currency conversion rate.

4. The method of claim 1, wherein the currency conversion rate is provided by the intermediary and wherein the currency conversion is performed by the intermediary.

5. The method of claim 1, wherein the transaction is initiated using a payment instrument with a party of the participants of the transaction and wherein the determination that the transaction requires currency conversion comprises:
determining that a currency assigned to the payment instrument is different from the currency accepted by the party.

6. The method of claim 5, wherein the party comprises any one or more of a merchant, distributor or vendor.

7. The method of claim 1, further comprising:
determining a monetary value from facilitating the currency conversion; and
providing the monetary value to be kept as revenue to one or more of the participants of the transaction.

8. The method of claim 7, wherein the monetary value is dependent on the converted currencies, the monetary value being in the form of a fixed amount, a percentage that depends on the currencies being converted, a tiered structure, or a combination thereof.

9. The method of claim 1, further comprising seeking approval for payment of the transaction in the desired currency.

10. The method of claim 5, wherein the payment instrument is any one or more of a credit, debit, prepaid, commercial, bank and mobile wallet account that can exist in virtual or physical forms.

11. The method of claim 1, wherein determining that a transaction requires currency conversion comprises detecting for an identifier that when processed indicates that currency conversion is required.

12. A server for an intermediary that transmits messages between participants of a transaction which requires currency conversion, the messages enabling each of the participants to perform their part in the transaction, the intermediary server comprising:
at least one processor; and
at least one memory including computer program code;
the at least one memory and the computer program code configured to, with the at least one processor, cause the intermediary server at least to:
obtain a currency conversion rate for the currency conversion; and
facilitate the currency conversion using the currency conversion rate to obtain an amount of the transaction in a desired currency.

13. The intermediary server of claim 12, wherein the intermediary server is further configured to:
select the currency conversion rate from a plurality of rates each provided by a currency conversion service provider.

14. The intermediary server of claim 13, wherein upon selection, the intermediary server informs the currency conversion service provider providing the selected currency conversion rate to perform the currency conversion.

15. The intermediary server of claim 12, wherein the intermediary server is further configured to:
provide the currency conversion rate and perform the currency conversion.

16. The intermediary server of claim 12, wherein the intermediary server is further configured to:
determine a monetary value from facilitating the currency conversion, and provide the monetary value to be kept as revenue to one or more of the participants of the transaction.

17. The intermediary server of claim 16, wherein the intermediary server is further configured to:
determine the monetary value based on the currencies being converted; and
provide the monetary value to the one or more of the participants of the transaction in the form of a fixed amount, a percentage that depends on the currencies being converted, a tiered structure, or a combination thereof.

18. The intermediary server of claim 12, wherein the intermediary server is further configured to seek approval for payment of the transaction in the desired currency.

19. The intermediary server of claim 12, wherein the intermediary server is further configured to locate an identifier that indicates that currency conversion is required and process the identifier to cause the server to obtain the currency conversion rate for the currency conversion.

20. A server for an issuer of a payment instrument used to initiate a transaction which requires currency conversion, the issuer server comprising:
at least one processor; and
at least one memory including computer program code;
the at least one memory and the computer program code configured to, with the at least one processor, cause the server at least to:
communicate with an intermediary server, the intermediary server comprising:
at least one processor; and
at least one memory including computer program code;
the at least one memory and the computer program code configured to, with the at least one processor, cause the intermediary server at least to:
obtain a currency conversion rate for the currency conversion; and
facilitate the currency conversion using the currency conversion rate to obtain an amount of the transaction in a desired currency; and
receive the amount of the transaction in a currency accepted by a party where the transaction is initiated.
